(19) United States
(12) Patent Application Publication
(10) Pub. No.: US 2014/0283116 A1
(43) Pub. Date: Sep. 18, 2014

(54) METHOD FOR PROTECTED EXECUTION OF CODE AND PROTECTION OF EXECUTABLE CODE AND DATA AGAINST MODIFICATIONS

(71) Applicant: Alexander Nikolaevich Zatsepin, Moscow (RU)

(72) Inventor: Alexander Nikolaevich Zatsepin, Moscow (RU)

(73) Assignee: Protection Technologies Research, LLC, Moscow (RU)

(21) Appl. No.: 13/989,789

(22) PCT Filed: Mar. 18, 2013
(86) PCT No.: PCT/RU2013/000215

§ 371 Date: Jun. 5, 2013

(51) Int. Cl. G06F 21/62

(52) U.S. Cl. CPC G06F 21/62
USPC 726/27

(57) ABSTRACT

A method for an automated protection of a programmable code and data without using dedicated components for calculation of the checksums and/or hash values is provided. Execution of each machine instruction uses data from several small blocks of protected code or data. Each of the blocks can be used in forming several machine instructions. If an intruder changes even one of the code blocks or data, it results in incorrect decoding of several machine instructions. Thus, the entire application does not work correctly. The intruder cannot neutralize a code protection mechanism.

### CROSS REFERENCE TO RELATED APPLICATIONS

The present application is a US National Phase of PCT/RU2013/000215, filed on Mar. 18, 2013.

### BACKGROUND OF THE INVENTION

1. Field of the Invention

The present invention is related to protection of machine code, and more particularly, to automated protection of program code and data against modification by intruders in the context of Digital Rights Management (DRM).

2. Description of the Related Art

Conventional systems for protection of applications against unauthorized use typically require some means for protection of the actual code and vital data from modifications. The conventional Digital Rights Management (DRM) systems frequently employ checksums and hash values for ensuring the integrity of data.

The checksums or hash values are calculated for portions of a program code and data. The checksums and/or hash values are calculated by dedicated program components. Use of the dedicated components creates some vulnerability, since the intruders can find these components and neutralize them. Thus, the code and data can be modified by the intruder and the DRM system cannot easily detect these harmful modifications.

Accordingly, a reliable method for an automated protection of a programmable code and data without using dedicated components for calculation of the checksums and/or hash values is desired.

### SUMMARY OF THE INVENTION

The present invention is intended as a method for protected execution of code and protection of executable code and data against modifications that substantially obviates one or several of the disadvantages of the related art.

In one aspect, a method for protected execution of code and an automated protection of a programmable code and data without using dedicated components for calculation of the checksums and/or hash values is provided.

According to an exemplary embodiment, each machine instruction uses data from several small blocks of protected code or data. Each of the blocks can be used in forming several machine instructions. If an intruder changes even one of the code blocks or any data, it will result in incorrect decoding of several machine instructions. Therefore, the entire application does not work correctly. Thus, the integrity of the executable machine code and protection of the application code and data against modifications is provided. The intruder cannot neutralize a code protection mechanism as described herein.

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE ATTACHED FIGURES

The accompanying drawings, which are included to provide a further understanding of the invention and are incorporated in and constitute a part of this specification, illustrate embodiments of the invention and, together with the description, serve to explain the principles of the invention.

In the drawings:

FIG. 1 illustrates a flow chart of a method for execution of code that provides protection against code and data modification, in accordance with the exemplary embodiment;

FIG. 2 illustrates a schematic diagram of an exemplary computer (node) or server that can be used in the invention.

### DETAILED DESCRIPTION OF THE PREFERRED EMBODIMENTS

Reference will now be made in detail to the preferred embodiments of the present invention, examples of which are illustrated in the accompanying drawings.

According to the exemplary embodiment, a method for protected execution of code and protection of code and data from modification is provided. The execution of each machine instruction uses data from several small blocks of protected code or data. Each of the blocks is used in forming several machine instructions. If an intruder changes even one of the code blocks or data, it results in incorrect decoding of several machine instructions. Thus, the entire application does not work. Thus, the integrity of the executable machine code is maintained, and protection of the application code and data against modifications is provided. The intruder cannot neutralize the code protection mechanism described herein.

According to the exemplary embodiment, the method is implemented on a computer system having a processor and an operating memory. The memory contains unchangeable (protected) code, protected unchangeable data, changeable data, a dynamic memory area, a stack area and so on. The computer system also has external peripheral devices connected to it.

According to another exemplary embodiment, the code protection method can be implemented on a virtual processor executed on the computer system. The proposed method protects against modification of unchangeable code, unchangeable data, and a code of the virtual processor.

In other words, there are two options: create new real hardware processor with new principles of command fetching/decoding; and create a virtual processor (i.e. a program that behaves as a processor) and implement the described principles in it.

According to the exemplary embodiment, the following conditions need to be met for effective protection:
the elements protected against modification are constant (i.e., not changeable);
the location of the protected elements in the operating memory is mutually consistent (not changeable according each other) at each loading of the protected application into the memory.

Conventional processors execute code as follows:
the processor fetches code of machine instruction from the operating memory using the instruction address. The instruction address is contained in a special register of the processor (instruction pointer register);
the processor decodes the machine code instruction;
the processor executes the machine instruction and writes the execution results into the operating memory or onto an external storage device. Note that the execution of the machine code instruction changes the state of the computer system and/or external devices.
the processor moves to the next machine instruction by changing the instruction pointer.

The above steps are repeated for all of the instructions.

According to the exemplary embodiment, the processor (real or virtual) has not one instruction pointer register, as conventional processor, but N instruction pointer registers (e.g., N=4). To execute instructions, the processor (real or virtual) performs the following steps:
the processor fetches N values at the instruction addresses contained in the instruction pointers. The N values are called partial machine codes;
the processor merges the partial machine codes into one instruction code. The length of the instruction code equals to the length of the partial codes. The merge operation is performed using logical XOR operation, and/or arithmetical ADD operation;
the processor executes the machine instruction and writes the execution results into the operating memory or onto external storage device. The execution of the machine code instruction changes the state of the computer system and/or external devices;
the processor moves to the next instruction. If the instruction is not a control transfer instruction (i.e., if the instruction does not change a natural execution order of the instructions), the move to the next instruction is implemented by increasing each of the N instruction pointers by the length of the executed instruction;

If the instruction is a control transfer instruction (i.e., if the instruction changes a natural execution order of the instructions), the move to the next instruction is implemented by increasing M of N instruction pointers (0≦M<N) by a length of the executed instruction and placing the remaining N−M instruction pointer at the target address defining the point where the control is passed to (e.g., the target address of a “goto Label” instruction is the address of the label “Label”).

Merging of the partial machine codes produces redundant data for coding the instructions, because the length of the instruction code equals the length of the partial instruction code. Thus, in order to code the instruction, a data block of a length of one partial code is sufficient. However, the N codes are used.

According to the exemplary embodiment, the N times redundancy is used for protection of code against the modification. The redundant partial codes of instructions (N−1) are taken from the code to be protected. The remaining one basic partial instruction code is calculated at time of code generation in such a manner that merging of the partial codes produces the correct value of the instruction code.

Consider the example of generating machine code for instruction “add v1, v2”. Let the required code of this instruction for this processor is 0x85 (this is a “correct code”). Let N=4, the merging operation is XOR. Let us suppose that three (N−1) values (i.e. partial codes) from protected code are 0x12, 0x03, 0x55. Now we should to calculate one remaining partial code to be generated. During the execution, the instruction code will be calculated as follows:

code=partial_code1 XOR partial_code2 XOR partial_code3 XOR partial_code4.

We have an equation:

0x85=0x12 XOR 0x03 XOR 0x55 XOR remaining_code

Solving it, remaining_code=0xC1.

Note that partial codes of some instructions can be used for protection of other instructions. In other words, the code, advantageously, protects itself from modification. The code of the virtual processor can be protected in the same manner. A degree of protection against the modification depends on N and on α (an aggregate size of instruction codes divided by the aggregate size of protected elements). Each byte of the protected elements participates in forming α×N instructions on average.

A change of any byte of a protected element by an intruder results in unpredictable to the intruder changing of an average of α×N instructions. This, in turn, results in disablement of the application implemented by the instructions. The typical behavior of application with unpredictable changed instruction is accessing of a non-existent address in memory or generating an exception during execution of incorrect instruction code.

FIG. 1 illustrates a flow chart of a method for protection against code modification, in accordance with the exemplary embodiment. In step 120, the process assigns N instruction pointers to the first instruction. In step 130, the process fetches N values (partial machine codes) at the instruction address contained in the instruction pointers. In step 140, the process merges the partial machine codes into one instruction code. The length of the instruction code equals to the length of the partial codes.

Then, in step 150, the process executes the machine instruction and writes the execution results into the operating memory or onto external device. The execution of the machine code instruction changes the state of the computer system and/or external devices. In step 160, the processor moves to the next instruction. If, in step 170, the instruction is not a control transfer instruction (i.e., the instruction, which does not changes a native order of the instructions), the move to the next instruction is implemented by increasing each of the N instruction pointers by the length of the executed instruction in step 180.

If, in step 170, the instruction is a control transfer instruction (i.e., the instruction, which changes a native order of the instructions), the move to the next instruction is implemented by increasing M of N instruction pointers (0≦M<N) by a length of the executed instruction and placing the remaining N−M instructions at the target address defining the point where the control is passed to in step 190.

With reference to FIG. 2, an exemplary system for implementing the invention includes a general purpose computing device in the form of a personal computer (or a node) 20 or server or the like, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read-only memory (ROM) 24 and random access memory (RAM) 25.

A basic input/output system 26 (BIOS), containing the basic routines that help to transfer information between elements within the computer 20, such as during start-up, is stored in ROM 24. The personal computer/node 20 may further include a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD-ROM, DVD-ROM or other optical media.

The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide non-volatile storage of computer readable instructions, data structures, program modules and other data for the personal computer 20.

Although the exemplary environment described herein employs a hard disk, a removable magnetic disk 29 and a removable optical disk 31, it should be appreciated by those skilled in the art that other types of computer readable media that can store data that is accessible by a computer, such as magnetic cassettes, flash memory cards, digital video disks, Bernoulli cartridges, random access memories (RAMs), read-only memories (ROMs) and the like may also be used in the exemplary operating environment.

A number of program modules may be stored on the hard disk, magnetic disk 29, optical disk 31, ROM 24 or RAM 25, including an operating system 35. The computer 20 includes a file system 36 associated with or included within the operating system 35, such as the WINDOWS NT™ File System (NTFS), one or more application programs 37, other program modules 38 and program data 39. A user may enter commands and information into the personal computer 20 through input devices such as a keyboard 40 and pointing device 42.

Other input devices (not shown) may include a microphone, joystick, game pad, satellite dish, scanner or the like. These and other input devices are often connected to the processing unit 21 through a serial port interface 46 that is coupled to the system bus, but may be connected by other interfaces, such as a parallel port, game port or universal serial bus (USB). A monitor 47 or other type of display device is also connected to the system bus 23 via an interface, such as a video adapter 48.

In addition to the monitor 47, personal computers typically include other peripheral output devices (not shown), such as speakers and printers. A data storage device, such as a hard disk drive, a magnetic tape, or other type of storage device is also connected to the system bus 23 via an interface, such as a host adapter via a connection interface, such as Integrated Drive Electronics (IDE), Advanced Technology Attachment (ATA), Ultra ATA, Small Computer System Interface (SCSI), SATA, Serial SCSI and the like.

The computer 20 may operate in a networked environment using logical connections to one or more remote computers 49. The remote computer (or computers) 49 may be another personal computer, a server, a router, a network PC, a peer device or other common network node, and typically includes many or all of the elements described above relative to the computer 20.

The computer 20 may further include a memory storage device 50. The logical connections include a local area network (LAN) 51 and a wide area network (WAN) 52. Such networking environments are commonplace in offices, enterprise-wide computer networks, Intranets and the Internet. When used in a LAN networking environment, the personal computer 20 is connected to the local area network 51 through a network interface or adapter 53.

When used in a WAN networking environment, the personal computer 20 typically includes a modem 54 or other means for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used.

Those skilled in the art will appreciate that proposed method allows for effective protection of machine code instructions and data. Having thus described a preferred embodiment, it should be apparent to those skilled in the art that certain advantages of the described method and apparatus have been achieved.

It should also be appreciated that various modifications, adaptations and alternative embodiments thereof may be made within the scope and spirit of the present invention. The invention is further defined by the following claims.

What is claimed is:

1. A computer-implemented method for protected execution of code, the method comprising:
(a) fetching N partial codes corresponding to the machine code instruction from a memory;
(b) merging the N partial machine codes into one instruction;
(c) executing the instruction and writing execution results into the memory;
(d) if the instruction is a control transfer instruction, increasing M of N instruction pointers by a length of the executed instruction, where 0≦M<N, and placing N−M instructions at a memory address defining a point to where the control is transferred; and
(e) if the instruction is not a control transfer instruction, increasing each of N instruction pointers by the length of the executed instruction.

2. The method of claim 1, wherein the N partial machine codes are stored at different memory addresses.

3. The method of claim 1, wherein each of the N partial machine codes is used for generating a machine code of more than one machine instruction.

4. The method of claim 1, wherein the N partial machine codes are unchangeable data stored in the memory.

5. The method of claim 1, wherein the merging of the N partial machine codes into one instruction comprising executing logical logical XOR and/or arithmetical ADD operations.

6. The method of claim 1, wherein the steps (a)-(e) are executed by a virtual processor.

7. The method of claim 6, wherein virtual processor code is protected using the steps (a)-(e).

8. A system for protection of machine code and data against modifications comprising:
a processor;
a memory coupled to the processor;
a computer program logic stored in the memory and executed on the processor, the computer program logic for executing the steps (a)-(e) of claim 1.
